(19) United States
(12) Patent Application Publication
(10) Pub. No.: US 2008/0137344 A1
(43) Pub. Date: Jun. 12, 2008

(54) Lamp Module for Projectors

(75) Inventors: Richard Lang, Kinding (DE); Gerhard Loffler, Eichstatt (DE); Thomas Mehr, Dollnstein (DE); Dirk Rosenthal, Gaimersheim (DE)

Correspondence Address: OSRAM SYLVANIA INC, 100 ENDICOTT STREET, DANVERS, MA, 01923, US

(73) Assignee: Patent- Treuhand-Gesellschaft Fur Elektrische Gluhlampen MBH, Munchen (DE)

(21) Appl. No.: 11/794,171

(22) PCT Filed: Dec. 20, 2005
(86) PCT No.: PCT/DE05/02298

§ 371 Date: Jun. 26, 2007

(30) Foreign Application Priority Data
Jan. 3, 2005 (DE) 102005000713.9

(51) Int. Cl. G03B 21/20; F21V 7/00

(52) U.S. Cl. 362/297; 29/428

(57) ABSTRACT

A lamp module for projectors, in particular for digital cinema and video projectors, has a reflector system which has at least two reflectors and in which a lamp is accommodated. The reflector system is electrically connected to the lamp and bears the lamp such that the reflector system and the lamp can be inserted into the projector as a preassembled unit and considerably simplifies assembly.

### TECHNICAL FIELD

The invention relates to a lamp module for projectors in accordance with the precharacterizing clause of patent claim 1 and to a method for positioning and making electrical contact with a lamp in such a lamp module in accordance with the precharacterizing clause of patent claim 25.

### PRIOR ART

Various projection technologies and performance features of modern projection systems allow for a large number of possible uses in the field of conventional and digital cinema and home cinema, but also place increasing demands on the quality of the light source and its assembly in the projectors.

In conventional cinema projectors, the lamp, for example a xenon short-arc high-pressure discharge lamp, is inserted into the reflectors already installed in the projector and is removed from the projector as an individual component and replaced at the end of its life. Owing to the necessary adjustment of the lamp in the projector, technically trained personnel are required to install the lamp in such systems, and these personnel need to wear suitable protective clothing owing to the risk of explosion of the lamp which is subjected to a high pressure.

For this reason, already preassembled lamp modules having reflectors inserted in a housing, in which case the lamp is accommodated in the housing, are used in video projection technology. The position of the lamp is adjusted as early as by the manufacturer by means of an adjustment device arranged on the housing, i.e. adjustment by the user is no longer necessary. The preassembled lamp module is positioned on the projector via a rail arranged on the housing and using aligning pins and is fixed by means of a flange. In this solution, the user is protected by the housing, which is closed with a filter disk, in the event of an “exploding lamp”, and further adjustment and thus trained personnel are not required owing to the fact that the lamp module is accommodated precisely in the projector.

One disadvantage of the above-described solution is the fact that the lamp modules have a high weight owing to the housing and the mechanical adjustment devices required and are very expensive owing to their complex design and manufacture.

### SUMMARY OF THE INVENTION

The invention is based on the object of providing a lamp module, in particular for digital cinema and video projectors, and a method for positioning and making electrical contact with a lamp in such a lamp module, in the case of which lamp module and method improved handling is possible with reduced manufacturing complexity compared to conventional solutions.

This object is achieved as regards the lamp module by the features of claim 1 and as regards the method for positioning and making electrical contact with a lamp in such a lamp module by the combination of features in claim 25. Particularly advantageous embodiments of the invention are described in the dependent claims.

The lamp module according to the invention has a reflector system which has at least two reflectors and in which a lamp is accommodated. According to the invention, the reflector system is electrically connected to the lamp and bears said lamp such that the reflector system and the lamp can be inserted into the projector as a preassembled unit.

The reflector system is preferably formed by two reflectors, a first reflector being formed with a light exit opening, and a second reflector being formed with a reflector neck, the lamp being mounted in the region of the reflector neck and the light exit opening.

Owing to the fact that the lamp is arranged in the interior of the reflector system, it is possible to dispense with a housing, as is required for safety reasons in the solution described in the prior art. Owing to the use of the reflector system as a mechanical and, at the same time, an electrical connecting element between the lamp and the projector, the manufacturing complexity of the lamp module is considerably reduced compared to the prior art. In this case, the current is transported via the reflector system of the lamp, in which case it needs to be taken into account that the reflector system with the lamp needs to be insulated from the further components of the projector.

In accordance with one particularly preferred exemplary embodiment, the reflector system has a spherical reflector as the first reflector and an elliptical reflector as the second reflector.

It has proven to be particularly advantageous to connect the two reflectors to one another along radially protruding planar faces which together form a flange, along which the lamp module can be fixed to the projector. For the mutual alignment of the two reflectors, an annular groove may be provided in the planar face or in the transition between the planar face and the reflector curvature of a reflector, a feather key on the other reflector engaging in said annular groove.

Positioning elements, for example positioning pins, are preferably provided on the flange which make it possible to mount the lamp module on the projector in a predetermined relative position. Owing to the defined positioning, no further adjustment of the lamp module is necessary and it is thus possible to insert the lamp module into the projector in a simpler manner and without any technical knowledge.

The spherical (first) reflector preferably has an attachment on the light exit side, which attachment is approximately in the form of a cone outer surface and merges with a fixing section, which is approximately in the form of a cylinder outer surface and delimits the light exit opening, for a filter holder.

The lamps which are used in such a lamp module are high-pressure discharge lamps. They comprise a lamp bulb and two lamp shafts fitted diametrically opposite one another on the lamp bulb. The electrode rods of the electrodes are fused into the lamp shafts in a gas-tight manner and are electrically connected to the contacts on the bases, which are fitted to the free ends of the lamp shafts.

A centering ring is advantageously inserted into the fixing section, in the form of a cylinder outer surface, of the reflector for the purpose of holding one base of the lamp. The centering ring preferably has inwardly protruding struts which are fixed to a metal sleeve arranged centrally in the centering ring. The metal sleeve serves the purpose of accommodating a conductive contact pin at the free end of the base.

The design of the lamp module is further simplified if the centering ring also bears a filter holder for a filter, in particular a UV/IR filter.

Effective cooling is required owing to the development of heat in the lamp and the associated limitation to its life. For this purpose, air can be blown into the reflector system or sucked out of it, for example via a fan, the cooling air flow produced surrounding the lamp body and effectively preventing the build-up of heat.

The attachment, in the form of a cone outer surface, of the first reflector preferably has a cutout, it being possible for a cooling air flow to enter or leave the reflector system through said cutout.

It is particularly advantageous if the reflector neck of the elliptical (second) reflector has an accommodating section, on which spring lugs are formed, it being possible for a cylindrical metal sleeve, which is pushed onto the other lamp shaft, to be accommodated and fixed between said spring lugs. The cylindrical metal sleeve is provided with a graphite tape and held by means of a clamping ring.

Owing to the difference in diameter between the reflector neck and a ceramic base fitted to the free end of the lamp shaft, the cooling air flow can enter or emerge from the reflector neck through the annular space produced, and cooling of the lamp can be ensured.

In order to ensure that the second reflector is held on the metal sleeve or on the lamp shaft, whilst at the same time ensuring that adjustment of the lamp in the reflector neck is possible, the spring lugs are preferably stamped free from the reflector neck and bent into the accommodating section. The spring lugs can also be milled out or produced by means of electroforming.

The cylindrical base, which is made from ceramic and is pushed onto the free end of the lamp shaft, reaches with its electrode-side end over that end of the cylindrical metal sleeve which is remote from the electrode. The base is held by the cylindrical metal sleeve by means of pairs of lugs which are bent out from the metal sleeve. Of these pairs of lugs, in each case one lug engages in a hole in the ceramic base, while the other lug supports the electrode-side end of the ceramic base.

A xenon short-arc high-pressure discharge lamp is preferably used as the lamp, since such lamps have particularly good color-rendering properties and high light densities and luminous fluxes, which make good image reproduction possible in optical projection systems.

In one preferred exemplary embodiment, electrical contact is made with the base at the end of the first lamp shaft by means of welding or soldering the electrical contact of the base to the accommodating reflector part. The electrical connection of the other electrode is produced by means of a contact element at the free end of the litz wire emerging from the ceramic base, which in turn is connected to the electrode rod.

As regards the design of the lamp module, the reflector system is made from an electrically conductive material, for example aluminum or nickel, or provided with an electrically conductive coating, and has a reflective coating.

The method according to the invention for positioning and making electrical contact with a lamp in such a lamp module takes place using the following steps:
a) inserting the lamp having a metal sleeve fixed on the second lamp shaft into the reflector system, the contact pin of the first base being inserted into the metal sleeve on the first reflector;
b) gripping the second lamp shaft of the lamp with an adjustment device and adjusting the lamp in the x, y and z direction with respect to the optical axis;
c) fixing the aligned lamp in the reflector system, in particular by means of welding or soldering the metal sleeve to the spring lugs on the second reflector and the contact pin of the first base to the sleeve on the centering ring of the first reflector;
d) pushing the ceramic base onto the second lamp shaft and fixing it there with a strain-relief device;
e) crimping the strain-relief device to the power supply litz wire; and
f) electrically connecting the free end of the power supply litz wire on the second base of the lamp to the power supply of the lamp via a contact element, in particular a contact plug.

It is particularly advantageous if the lamp protrudes at least in sections from the reflector system for the purpose of making electrical contact and/or for adjustment purposes in the lamp module. As a result, the lamp can be gripped better by the adjustment device and it is easier for the contact element to make contact with the lamp after the adjustment.

### BRIEF DESCRIPTION OF THE DRAWING(S)

The invention will be explained in more detail below with reference to a preferred exemplary embodiment. In the drawings:

FIG. 1 shows a side view of a lamp module according to the invention;

FIG. 2 shows a three-dimensional view of the lamp module from FIG. 1;

FIG. 3 shows a side view of a spherical reflector of the lamp module from FIG. 1;

FIG. 4 shows a three-dimensional view of the spherical reflector from FIG. 3;

FIG. 5 shows a detailed illustration of a centering ring from FIG. 2;

FIG. 6 shows a detailed illustrated of a filter holder from FIG. 2;

FIG. 7 shows a side view of an elliptical reflector of the lamp module from FIG. 1;

FIG. 8 shows a plan view of the elliptical reflector from FIG. 7;

FIG. 9 shows a three-dimensional view of the elliptical reflector from FIG. 7, and

FIG. 10 shows a section through the neck of the elliptical reflector with the metal sleeve inserted and the ceramic base attached.

### PREFERRED EMBODIMENT OF THE INVENTION

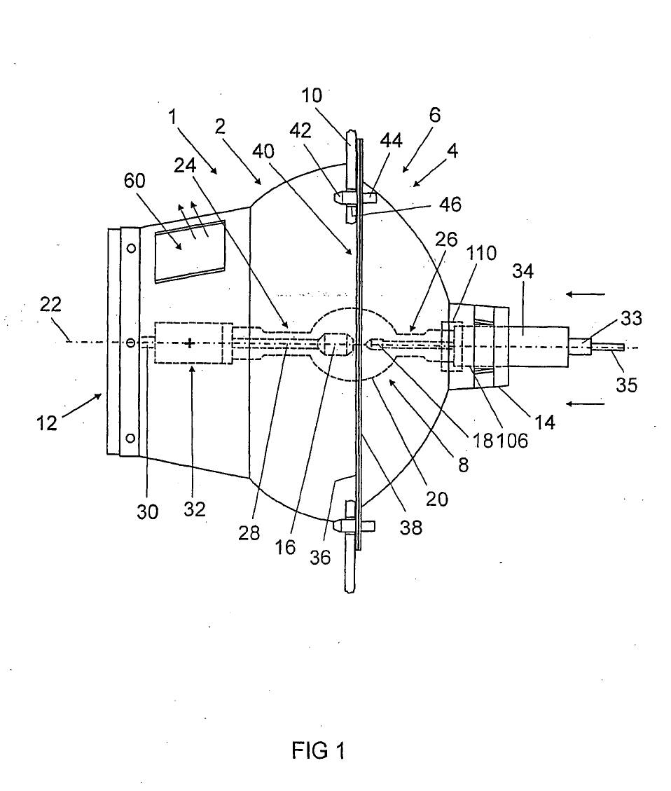

As shown in FIG. 1, the lamp module 1 according to the invention has a reflector system 6, which is formed by a first, spherical reflector 2 and a second, elliptical reflector 4 and in which a lamp 8 is accommodated. The lamp 8 is borne by the reflector system 6 and forms with said reflector system 6 a preassembled unit which is inserted such that it is electrically insulated on a wall 10 of a projector, for example a digital projector with LCD or DLP/DMD technology.

The spherical reflector 2 is formed with a light exit opening 12, and the elliptical reflector 4 is formed with a reflector neck 14, the lamp 8 being mounted according to the invention in the region of the reflector neck 14 and the light exit opening 12.

Effective cooling is required owing to the development of heat in the lamp 8 and the associated limitation to its life. For this purpose, air is blown into the reflector system 6, as indicated by arrows, via a fan (not illustrated). The cooling air flow surrounds the lamp 8 and effectively prevents the build-up of heat in the reflector system 6.

In the exemplary embodiment illustrated, the lamp 8 is in the form of a xenon short-arc high-pressure discharge lamp having a conventional design. Such a short-arc lamp essentially comprises an anode 16, a cathode 18, which are each mounted on an electrode rod 28, and a lamp bulb 20 filled with high-purity xenon gas. This lamp bulb 20 merges along an optical axis 22 on both sides with in each case one approximately cylindrical lamp shaft 24, 26, into which the electrode rods 28 of the anode 16 or the cathode 18 are fused in a gas-tight manner and electrically connected to a base system 32, 34 at the free end of the lamp necks 24, 26.

In the exemplary embodiment shown, electrical contact is made with the first base (anode base) 32 of the lamp 8 via the reflector system 6 and with the second base (cathode base) 34 with a strain-relief device 33 via a contact plug (not shown) at the free end of the power supply litz wire 35. The lamp shaft 26 protrudes from the reflector system on the cathode side to make it easier to adjust and make contact with the lamp 8 in the lamp module 1. As a result, the lamp 8 can be gripped better by an adjustment device (not shown) and it is easier to make contact with it via the base 34 and the power supply litz wire 35 after the adjustment. The reflector system 6 is made from an electrically conductive material and is provided with a reflective coating. Owing to the use of the reflector system 6 as a mechanical and electrical connecting element between the lamp 8 and the projector 10, the manufacturing complexity is considerably reduced compared to the prior art.

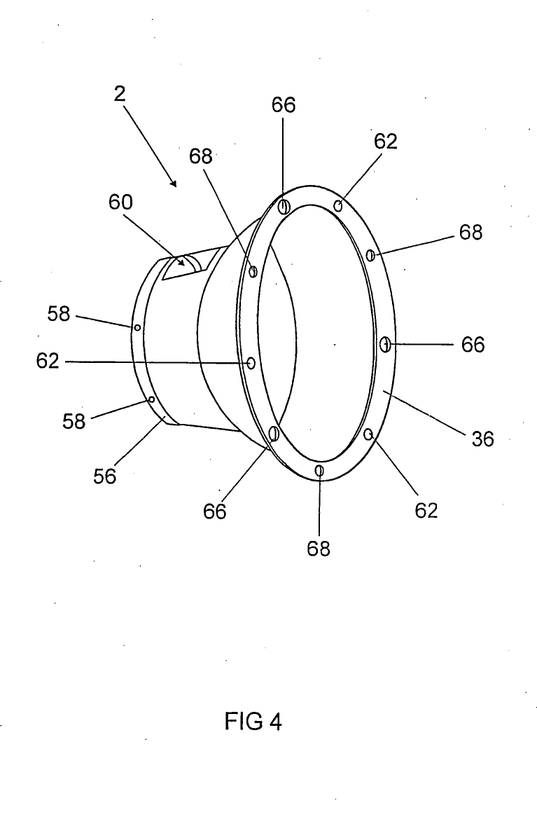

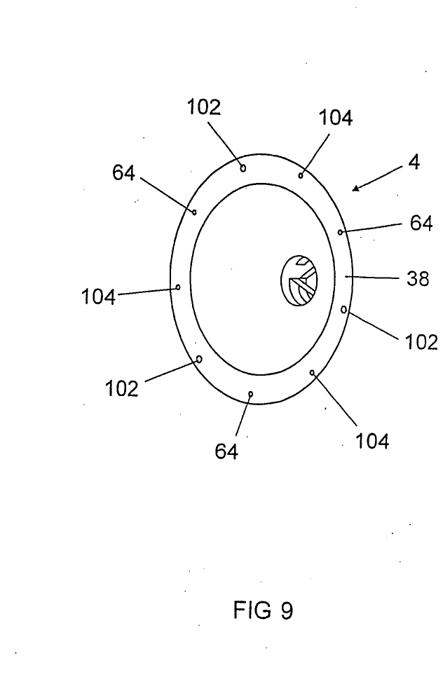

The spherical reflector 2 and the elliptical reflector 4 are connected to one another via radially protruding planar faces 36, 38 (cf. FIG. 4 and FIG. 9), which together form a flange 40, along which the lamp module 1 is fixed in an insulated manner to the projector 10.

Positioning pins 44 which are provided with an insertion bevel 42 are provided on the flange 40, are inserted into accommodating drilled holes 46 in the projector wall 10, which is fixed in an electrically insulated manner with respect to the rest of the housing, and make possible a defined position of the lamp module 1 on the projector without any adjustment by the user.

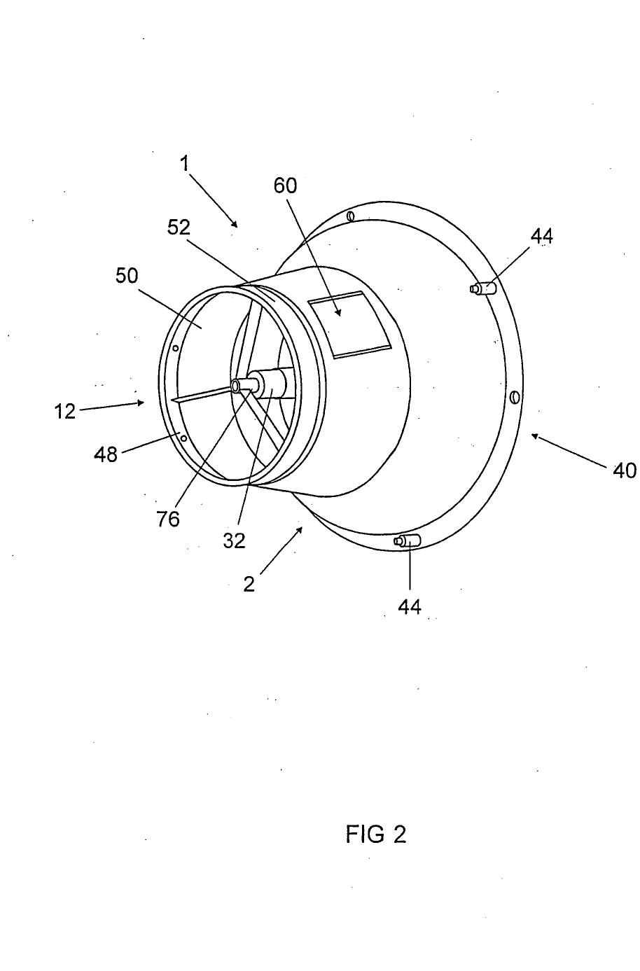

FIG. 2 shows a three-dimensional view (from the light exit opening 12) of the lamp module 1. Accordingly, a centering ring 48 having a sleeve 76 for the purpose of accommodating the contact 30 of the anode base 32 of the lamp 8 is inserted into the spherical reflector 2. The centering ring 48 also bears a UV/IR filter 50, which is held by a filter holder 52 on the light exit opening 12.

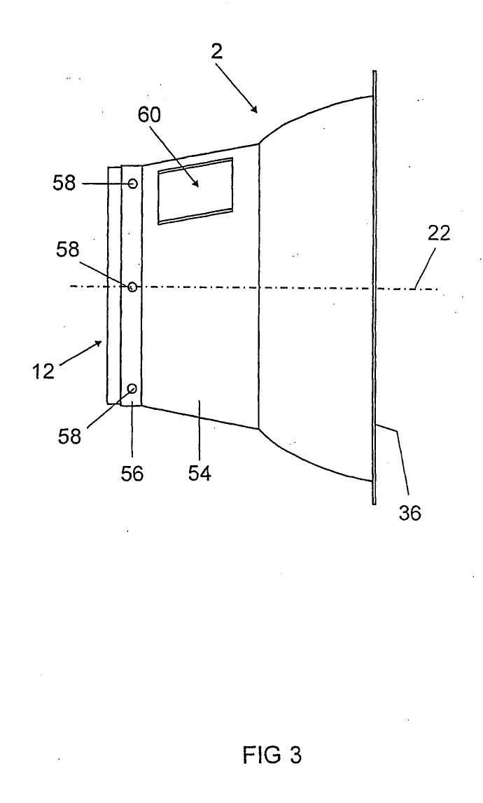

As can be seen in particular in FIG. 3, which shows a side view of the spherical reflector 2, the spherical reflector 2 has an attachment 54 on the light exit side, which attachment 54 is approximately in the form of a cone outer surface and merges with a fixing section 56, which is approximately in the form of a cylinder outer surface and delimits the light exit opening 12. The fixing section 56 is provided with drilled holes 58, which are distributed evenly over the circumference and into which fixing elements (not illustrated), for example screws or rivets, can be inserted for the purpose of fixing the centering ring 48 and the filter holder 52. The attachment 54 in the form of a cone outer surface has a stamped-out, approximately rectangular cutout 60, through which the cooling air flow can leave the reflector system 6 in the direction indicated by arrows (cf. FIG. 1).

FIG. 4 shows a three-dimensional illustration of the spherical reflector 2, in which case three symmetrically distributed knob-like positioning elevations 62 are arranged on the planar face 36 which protrudes radially at the ends, it being possible for said positioning elevations 62 to be brought into engagement with positioning depressions 64 in the planar face 38 of the elliptical reflector (cf. FIG. 9), and said positioning elevations 62 defining the position of the two reflectors 2, 4 with respect to one another in relation to the optical axis 22. Furthermore, three drilled through-holes 66 are formed in the planar face 36 for the purpose of accommodating the positioning pins 44, and three drilled through-holes 68 are formed in the planar face 36 for the purpose of fixing the elliptical reflector 4. The two reflectors 2, 4 are fixed, for example, by means of screws or rivets (not illustrated) which are inserted into the drilled holes 68.

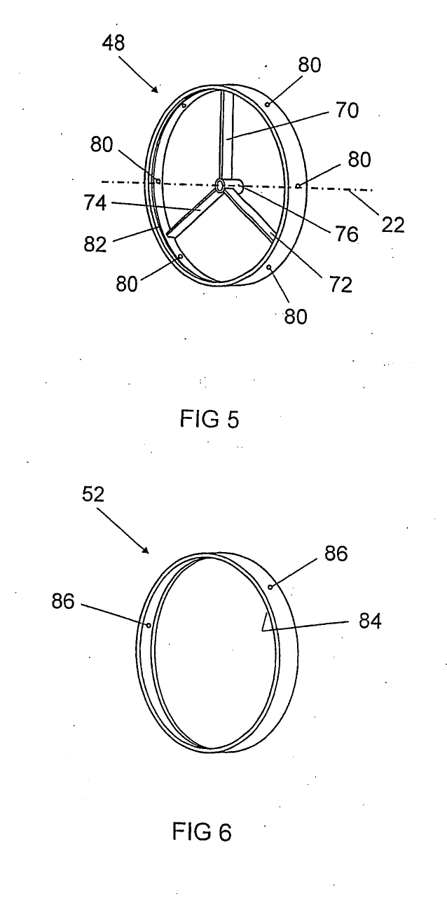

As shown in FIG. 5, three inwardly protruding struts 70, 72, 74 are formed approximately in the form of a star on the centering ring 48 and bear a sleeve 76, arranged centrally in the centering ring 48, for the purpose of accommodating the connection contact 30 (cf. FIG. 1) of the base 32 of the lamp 8, the centering ring 48 having a bevel on an inner edge opposite the light exit side, the struts 70, 72, 74 engaging behind said bevel in order to prevent shadowing. The sleeve 76 is displaced along the optical axis 22 rearwards in relation to the light exit side, into the reflector. The centering ring 48 can be connected to the fixing section 56 of the spherical reflector 2 by means of fixing elements (not illustrated) via drilled holes 80 distributed evenly on the circumference and has an end-side annular cutout 82 for the purpose of accommodating the filter disk 50.

FIG. 6 shows a three-dimensional illustration of the filter holder 52, which can be pushed onto the fixing section 56 of the spherical reflector 2, for the purpose of accommodating the UV/IR filter 50 (cf. FIG. 2). The filter holder 52 has an approximately L-shaped cross section, it being possible for the shorter limb 84 to be brought to bear at the end against the filter 50, said shorter limb 84 engaging around said filter 50 and thus fixing it on the lamp module 1. The filter holder 52 can be connected to the fixing section 56 of the spherical reflector 2 via fixing elements (not illustrated) via drilled holes 86 arranged over the circumference.

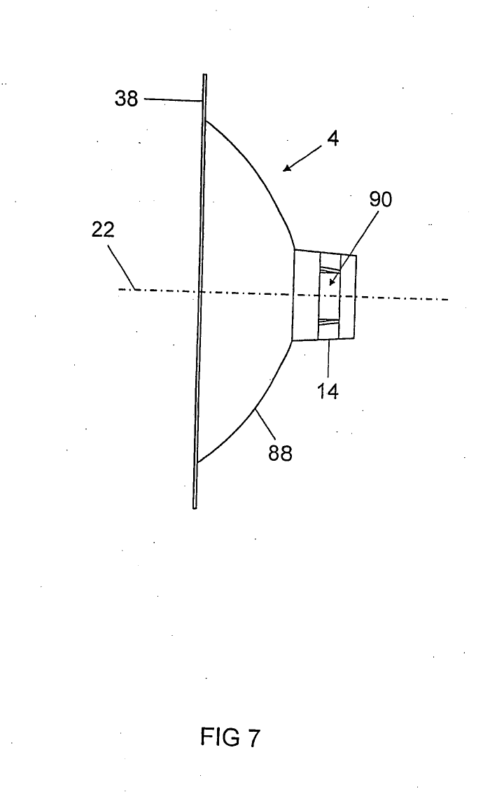

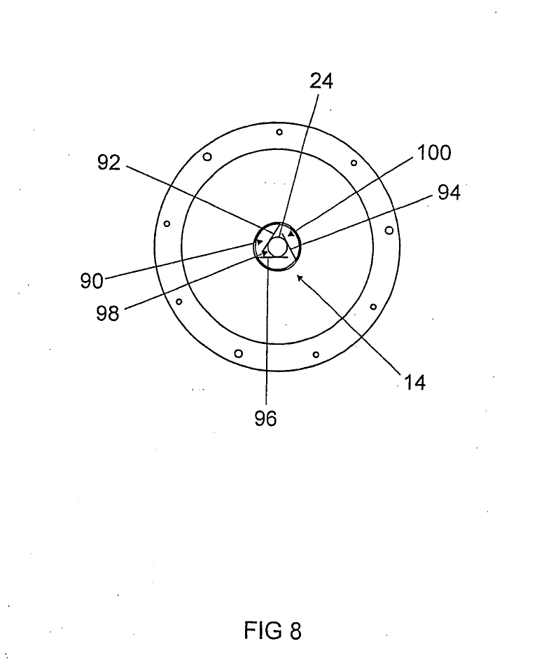

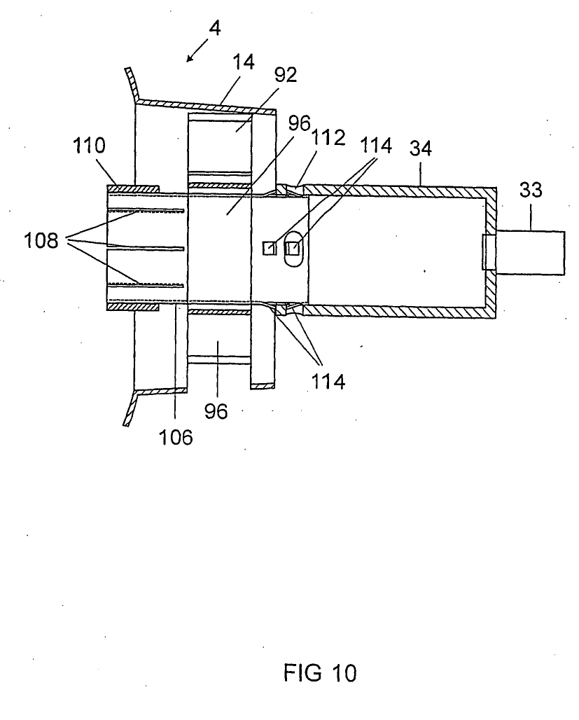

As can be seen in particular in FIG. 7, which shows a side view of the elliptical reflector 4, the elliptical reflector 4 has a face 88, which is in the form of a cone outer surface and merges with the reflector neck 14, which has an accommodating section 90, which is approximately in the form of a cylinder outer surface and on which three spring lugs 92, 94, 96 are formed, it being possible for the lamp neck 26 with a metal sleeve 106 pushed onto it to be accommodated and fixed between said spring lugs 92, 94, 96 (cf. FIG. 10). The spring lugs 92, 94, 96 are stamped free from the reflector neck 14, as shown in FIG. 8, and bent into the accommodating section 90 such that they bear at least in sections in a resilient manner against a circumferential surface of the metal sleeve 106 when the lamp 8 is inserted in order to achieve a secure hold of the lamp shaft 26 and at the same time to make it possible to adjust the lamp 8 in the reflector neck 14. The spring lugs 92, 94, 96 are welded or soldered to the sleeve 106, which is pushed onto the lamp shaft 26, after the adjustment of the lamp 8 in the reflector system 6. Owing to the difference in diameter between the reflector neck 14 and the lamp shaft 26, cooling of the lamp is further improved by the annular space 100 produced.

FIG. 9 shows a three-dimensional illustration of the elliptical reflector 4, in which case three symmetrically distributed positioning depressions 64 are arranged on the planar face 38 which protrudes radially at the ends, it being possible for said positioning depressions 64 to be brought into engagement with the positioning elevations 62 on the planar face 36 of the spherical reflector 2 (cf. FIG. 4), and said positioning depressions 64 defining the position of the two reflectors 2, 4 with respect to the optical axis 22. Furthermore, three drilled through-holes 102 are formed in the planar face 38 for the purpose of accommodating the positioning pins 44, and three drilled through-holes 104 are formed in the planar face 38 for the purpose of fixing the spherical reflector 2.

FIG. 10 shows a section through the neck 14 of the elliptical reflector 4. A cylindrical metal sleeve 106 is inserted into the neck 14 and is pushed over the lamp shaft 26, not shown here (cf. FIG. 1). The cylindrical metal sleeve 106 has a plurality of slots 108 extending in the axial direction of the lamp at its end facing the cathode. These slots 108 make it possible to fix the metal sleeve 106 on the lamp shaft 26 with the aid of a clamping ring 110, which is pushed over the electrode-side end of the metal sleeve 106. In order to protect the lamp neck, in this case the metal sleeve is also provided with a graphite tape (not illustrated here). With one of its ends, a ceramic base 34 is pushed onto the other end of the metal sleeve 106. The ceramic base 34 is held by lugs 114, which are stamped free from the metal sleeve 106, are bent up and which, on the one hand, engage in the holes 112 in the ceramic base 34 and, on the other hand, support the electrode-side end of the ceramic base 34. The ceramic base 34 also has a strain-relief device 33 in the form of a sleeve at the end remote from the cathode. Owing to this strain-relief device 33, the power supply litz wire 35, which is connected to the rod of the electrode (cathode), is pushed and crimped after assembly.

The lamp 8 is positioned and electrical contact is made with it in the lamp module 1 in essentially six steps. In a first working step, the lamp 8, with the metal sleeve 106 fixed on the second lamp shaft 26, is introduced into the reflector system 6, the contact pin 30 of the first base 32 being inserted into the metal sleeve 76 of the centering ring 48 on the first reflector 2. Then, the second lamp shaft 26 of the lamp 8 is gripped by an adjustment device (not illustrated), and the lamp 8 is adjusted in the x, y and z direction with respect to the optical axis 22, the connection contact 32 being capable of moving in the sleeve 76 and making adjustment easier. In a further working step, the metal sleeve 106 is welded or soldered to the spring lugs 94, 96, 98 on the second reflector 4, and the contact pin 30 of the first base 32 is welded or soldered to the sleeve 76 on the centering ring 48 of the first reflector 2, with the result that the reflector system 6 is electrically connected to the lamp 8. Then, the ceramic base 34 with the strain-relief device 33 is pushed onto the second lamp shaft 26 and fixed there, and the strain-relief device 33 is crimped with the power supply litz wire 35. The final connection between the second electrode (cathode) and the power supply system takes place by the free end of the power supply litz wire 35 being connected to the power supply of the lamp 8 via a contact element, in particular a contact plug.

The subject matter according to the invention is not restricted to the xenon short-arc high-pressure discharge lamp described but any projector lamp known from the prior art can be used.

The invention discloses a lamp module 1 for projectors 10 having a reflector system 6 which has at least two reflectors 2, 4 and in which a lamp 8 is accommodated. The reflector system 6 is electrically connected to the lamp 8 and bears said lamp 8 such that the reflector system 6 and the lamp 8 can be inserted into the projector 10 as a preassembled unit, and considerably simplifies assembly.

1. A lamp module (1) for projectors, in particular for digital cinema and video projectors, having a reflector system (6) which has at least two reflectors (2, 4) and in which a lamp (8) is accommodated which has a bulb (20) and two shafts (24, 26), which have an electrode system (16, 18) and bases (32, 34) at the ends of the shafts, characterized in that the reflector system (6) is electrically connected to the lamp (8) and bears said lamp (8) such that the reflector system (6) and the lamp (8) can be inserted into the projector (10) as a preassembled unit.

2. The lamp module for projectors as claimed in claim 1, the reflector system (6) comprising two reflectors (2, 4), the first reflector (2) being formed with a light exit opening (12) and the second reflector being formed with a reflector neck (14), and the lamp (8) being mounted in the region of the reflector neck (14) and the light exit opening (12).

3. The lamp module for projectors as claimed in claim 1, the two reflectors (2, 4) being connected along radially protruding planar faces (36, 38) which together form a flange (40), along which the lamp module (1) can be fixed to a projector (10).

4. The lamp module for projectors as claimed in claim 1, a reflector having an annular groove in the planar face or in the transition between the planar face and the reflector curvature, an annular feather key on the other reflector engaging in said annular groove.

5. The lamp module for projectors as claimed in claim 3, positioning elements (44) being provided on the flange (40) which make it possible to mount the lamp module (1) on the projector (10) in a defined manner.

6. The lamp module for projectors as claimed in claim 2, the first reflector (2) being a spherical reflector, and the second reflector (4) being an elliptical reflector.

7. The lamp module for projectors as claimed in claim 6, the reflector neck (14) of the second reflector (4) having an accommodating section (90), on which spring lugs (92, 94, 96) are formed, it being possible for the second lamp shaft (26) of the lamp (8) to be accommodated and fixed between said spring lugs (92, 94, 96).

8. The lamp module for projectors as claimed in claim 7, the spring lugs (92, 94, 96) being stamped free from the reflector neck (14) and being bent into the accommodating section (90).

9. The lamp module for projectors as claimed in claim 7, the spring lugs (92, 94, 96) being milled out from the reflector neck (14).

10. The lamp module for projectors as claimed in claim 7, the spring lugs (92, 94, 96) being produced from the reflector neck (14) by means of electroforming.

11. The lamp module for projectors as claimed in claim 1, the second lamp shaft bearing a cylindrical metal sleeve (106) at least in the region of the spring lugs (92, 94, 96).

12. The lamp module for projectors as claimed in claim 11, a graphite tape being located between the cylindrical metal sleeve (106) and the lamp shaft (26).

13. The lamp module for projectors as claimed in claim 11, the cylindrical metal sleeve (106) being held on the second lamp shaft (26) by a clamping ring (110).

14. The lamp module for projectors as claimed in claim 11, a cylindrical base (34) made from ceramic being pushed onto the free end of the lamp shaft (26) and onto that end of the cylindrical metal sleeve (106) which is remote from the electrode.

15. The lamp module for projectors as claimed in claim 14, the cylindrical base (34) being held by the cylindrical metal sleeve (106) by means of pairs of lugs (114) which are bent out from the metal sleeve (106).

16. The lamp module for projectors as claimed in claim 6, the first reflector (2) having an attachment (54) on the light exit side, which attachment (54) is approximately in the form of a cone outer surface and merges with a fixing section (56), which is approximately in the form of a cylinder outer surface and delimits the light exit opening (12).

17. The lamp module for projectors as claimed in claim 16, a centering ring (48) being inserted into the fixing section (56), in the form of a cylinder outer surface, for the purpose of accommodating the base (32) of the first lamp shaft (24) of the lamp (8).

18. The lamp module for projectors as claimed in claim 17, the centering ring (48) having inwardly protruding struts (70, 72, 74) which are fixed to a sleeve (76), arranged centrally in the centering ring (48), for the purpose of accommodating a connection contact (30) on the base (32) of the first lamp shaft (24) of the lamp (8).

19. The lamp module for projectors as claimed in claim 17, the centering ring (48) bearing a filter holder (52) for a filter (50), in particular a UV/IR filter.

20. The lamp module for projectors as claimed in claim 16, the attachment (54), in the form of a cone outer surface, having at least one cutout (60), it being possible for a cooling air flow to enter or leave the reflector system (6) through said cutout (60).

21. The lamp module for projectors as claimed in claim 1, the lamp (8) being a xenon high-pressure discharge lamp.

22. The lamp module for projectors as claimed in claim 1, electrical contact being made with the base (32) on the first lamp shaft (24) of the lamp (8) via the reflector (2) and with the base (34) on the second lamp shaft (26) via a contact element at the free end of the power supply litz wire (35).

23. The lamp module for projectors as claimed in claim 1, the reflector system (6) being made from an electrically conductive material, in particular aluminum or nickel, or provided with an electrically conductive coating, and having a reflective coating.

24. The lamp module for projectors as claimed in claim 1, at least one end section of the lamp (8) protruding at least in sections from the reflector system (6) for the purpose of making electrical contact and/or for adjustment purposes in the lamp module (1).

25. A method for positioning and making electrical contact with a lamp (8) in a reflector system (6) of a lamp module (1), in particular as claimed in claim 1, having the following steps:
a) inserting the lamp (8) having a metal sleeve (106) fixed on the second lamp shaft (26) into the reflector system (6), the contact pin (30) of the first base (32) being inserted into the metal sleeve (76) on the first reflector (2);
b) gripping the second lamp shaft (26) of the lamp (8) with an adjustment device and adjusting the lamp (8) in the x, y and z direction with respect to the optical axis;
c) fixing the aligned lamp (8) in the reflector system (6), in particular by means of welding or soldering the metal sleeve (106) to the spring lugs (94, 96, 98) on the second reflector (4) and the contact pin (30) of the first base (32) to the sleeve (76) on the centering ring of the first reflector (2);
d) pushing the ceramic base (34) onto the second lamp shaft (26) and fixing it there with a strain-relief device (33);
e) crimping the strain-relief device (33) to the power supply litz wire (35); and
f) electrically connecting the free end of the power supply litz wire (35) on the second base (34) of the lamp (8) to the power supply of the lamp via a contact element, in particular a contact plug.
